(19) United States
(12) Patent Application Publication
(10) Pub. No.: US 2021/0370303 A1
(43) Pub. Date: Dec. 2, 2021

(54) PRESSURE INSENSITIVE MICROFLUIDIC CIRCUIT FOR DROPLET GENERATION AND USES THEREOF

(71) Applicant: Thunderbio Innovation Ltd, Hong Kong (CN)

(72) Inventors: Xiaonan XU, Jieyang (CN); Ruyuan SONG, Huanghua (CN); Shuhuai YAO, Hong Kong (CN); Kwok Fai Joseph CHOW, Hong Kong (CN)

(21) Appl. No.: 17/285,904

(22) PCT Filed: Oct. 19, 2019
(86) PCT No.: PCT/CN2019/111400

§ 371 Date: Apr. 15, 2021

Related U.S. Application Data
(60) Provisional application No. 62/747,657, filed on Oct. 18, 2018.

(51) Int. Cl. B01L 3/00

(52) U.S. Cl. CPC B01L 3/502784; B01L 2200/0673; B01L 2300/0867; B01L 2400/0478

(57) ABSTRACT

The present invention provides a microfluidic circuit for generating uniform droplets despite fluctuations in pressure, and manufacturing methods and uses thereof. Said circuit comprises microfluidic channels for carrying a continuous phase and a dispersed phase. In one embodiment, the ratio of the flow resistance of the dispersed phase to that of the continuous phase is equal to the ratio of the flow rate of the continuous phase to that of the dispersed phase. In one embodiment, the present microfluidic circuit comprises two features to achieve the desired ratio of flow resistance and flow rate of the dispersed phase and continuous phase: (a) using a single pressure source which applies identical pressure to the inlets of the upstream channels carrying the two phases, and (b) the flow resistance of the dispersed phase and continuous phase is much higher than the flow resistance of the downstream channel so that the flow resistance of the downstream channel become negligible.

### CROSS REFERENCE TO RELATED APPLICATION

The present application claims priority of U.S. Patent provisional Application No. 62/747,657, filed on Oct. 18, 2018. The content of this application including all tables, diagrams and claims is incorporated hereby as reference in its entity.

### FIELD OF THE INVENTION

The present invention relates to microfluidic circuits for generating droplets and uses thereof.

### BACKGROUND OF THE INVENTION

Droplets or emulsions in microfluidic systems can work as “miniaturized mobile reactors” for chemical and biological assays, owing to their unique features such as high-throughput, rapid response, being contamination-free, requiring minimal reagent volume, and isolation of individual space. For instance, the commercialized droplet-based digital polymerase chain reaction (ddPCR) technology, in which a diluted sample is partitioned into a sufficient number of reaction aliquots that allow single-molecule amplification and absolute quantification of the target gene, has attracted tremendous interest in various applications, from prenatal screening of fetal genomic abnormalities and inherited disorders to detection of cancer and infectious diseases through the detection of sequences rarely present or of extremely low abundance. In industries of food, pharmaceuticals, cosmetics and oils, monodisperse emulsions with well-defined compositions are highly desired and widely used as templates for microparticle or microcapsule fabrication. However, for the applications of droplet microfluidics, currently it still requires complicated experimental setups and the expertise of microfluidics for device operation. For laboratories of biology and chemistry which do not have experience in droplet microfluidics, applications of such powerful tool would be limited. Also, from the industrial perspective, the tooling development of droplet microfluidics for molecular diagnostics would be an important benchmark for various successful applications.

Droplets are usually generated by emulsion in which one liquid (the dispersed phase) is in the form of microscale droplets dispersed in the other liquid (the continuous phase). The two phases are immiscible such as oil and water. In microfluidic systems, the dynamics of droplet formation is dominated by the balance of tangential shear stresses and interfacial tension[1-2].

Droplet generation can be substantially affected by flow conditions of the microfluidic system such as flow velocity, fluid viscosity and interfacial tension of two phases. Since the geometry of the channels and the fluids are usually fixed in operation of the microfluidic device, flow rates of continuous phase and dispersed phase are more decisive than other flow conditions. Flow rate can be controlled through applying a pump, for example, a syringe pump or a pressure pump to the device.

In shear-based systems such as T-junction, flow-focusing, or co-flow designs, hydrodynamic force is employed for breaking the stream into droplets by the coupling of the flow rates and fluid properties of the two phases, and nozzle geometry. First of all, shear-based systems require two pressure sources for droplet generation and therefore involve a relatively complicated pressure circuit. Secondly, tight control over the flow rate of the dispersed and continuous phases is needed for generating monodisperse droplets[3]. Variation in one or more of these parameters would result in different trains of droplets population. Therefore, precise pressure pumps or syringe pumps are required to control the flow rate and hence droplet generation. Chip interfaces also need to be carefully designed such that sample can be effectively loaded to the chip while retaining the high requirement of air impermeability.

Instead, in interfacial tension driven systems, e.g., step emulsification[4], the abrupt change in cross-sectional height of the nozzle induces a Laplace pressure difference for spontaneous droplet generation, which is relatively insensitive to the flow rate or pressure. The droplet self-breakup process is predominantly driven by the interface between the two phases, thus eliminating the shear stress interference. To date, various self-emulsification structures have been developed including the grooved-type microchannel[5], straight-through microchannel[5-7], edge-based droplet generation (EDGE)[8] and gradient of confinement[9]. Nevertheless, widespread adoption of interfacial tension induced droplet generators has been hindered due to less robustness in device operation or the cumbersome process for device fabrication. To date, interfacial tension-based droplet generation has three main drawbacks. First, the droplet generation frequency is low which is at least 10 times lower than the shear-based system. Second, the initial conditions for droplets generation are more rigid and bubbles trapping in the channel may seriously affect the droplet generation process and result in failure of the whole experiment. Third, although the droplet generation is relatively robust, the range of permissible pressure variation for a stable droplet generation is limited to around 1 psi and therefore cannot fully meet the need for convenient operation.

In summary, sensitivity to pressure fluctuations in droplet generation in microfluidics remains a significant yet unsolved issue in the art. It is desirable to have a robust and simplified microfluidic circuit that is not sensitive to changes in pressure and therefore capable of producing uniform droplets in a more cost-effective and convenient manner.

### SUMMARY OF THE INVENTION

To this end, it is desirable to provide a microfluidic system that is not sensitive to changes in pressure and therefore capable of producing uniform droplets. It is desirable to have a robust and simplified microfluidic circuit that is not sensitive to changes in pressure and therefore capable of producing uniform droplets in a more cost-effective and convenient manner.

The present provides a method of designing or preparing a microfluidic circuit which is less sensitive to pressure fluctuations as compared to current designs and able to generate droplets consistently and efficiently. The present microfluidic circuit can be integrated into various machines or systems for a wide range of applications.

In one aspect of the present invention, a device or system for generating droplets is provided. The device or system comprises an upstream channel and a downstream channel, the upstream channel is used for transporting liquid, and the downstream channel is used for transporting droplets, wherein the flow resistance of the upstream channel is greater than or much greater than the flow resistance of the downstream channel. Under such conditions, the resulting droplets have uniform or same size but are not sensitive to the changes in pressure.

That is, the external pressure applied to the upstream liquid allows the liquid to move in the channel, and the change in pressure will not or will substantially not produce influence on the droplet size.

In some embodiments, the upstream channel includes a microfluidic system or a microfluidic channel that is in fluidic communication. In some embodiments, the upstream channel includes a microfluidic channel. The downstream channel includes a fluid channel or a microfluidic channel.

In some embodiments, droplets are generated at the junction of the upstream channel and the downstream channel, or the junction of the upstream and downstream is used to generate droplets; alternatively, if there are a plurality of channels at the upstream, droplets are generated in the junction of several of the plurality of channels at the upstream, and the generated droplets flow to the downstream channel to transport.

Alternatively, the device includes a portion that produces droplets, and the portion divides the microfluidic channel or system into an upstream portion and a downstream portion; or the portion that generates droplets is a boundary point, a dividing line, an interface, a boundary between the upstream and downstream. The upstream and downstream are divided or determined based on the droplet generating location. In some preferred embodiments, the portion generating droplets is also located in the channel that is in fluidic communication with the upstream channel and the downstream channel. Thus, the flow resistance of the upstream channel of the portion generating droplets is greater than or much greater than that of the downstream microfluidic channel, such that the flow resistance of the downstream channel is almost negligible.

In some embodiments, the liquid includes a disperse phase liquid and a continuous phase liquid. In some embodiments, the upstream microfluidic system or channel includes a first portion of channel for transporting the disperse phase liquid and/or a second portion of channel for transporting the continuous phase liquid. In some embodiments, the portion that generates droplets is in fluidic communication with the first portion and the second portion. In some embodiments, the channel of the disperse phase liquid intersects with the channel of the continuous phase liquid, generating droplets at the junction, and the downstream of the junction includes a channel for transporting the droplets. The flow resistance of the channel upstream at the junction is greater than or much greater than the flow resistance of the downstream channel at the junction.

In some embodiments, the downstream microfluidic channel is in fluidic communication with the first portion and the second portion of the channel. In some other embodiments, the downstream microfluidic channel is in fluidic communication with the droplet generating portion; alternatively, the downstream fluid channel is in fluidic communication with the upstream microfluidic channel through the droplet generating portion.

There are many ways to make the upstream flow resistance greater than the downstream flow resistance, and all ways that can affect the flow resistance change are within the scope of the present invention. The specific method will be described in detail later.

In some embodiments, the length of the upstream microfluidic channel is greater than or much greater than the length of the downstream microfluidic channel.

In some embodiments, the diameter of the upstream microfluidic channel is smaller or much smaller than the diameter of the downstream microfluidic channel.

In some embodiments, the cross-sectional area of the upstream microfluidic channel is less than or much less than the cross-sectional area of the downstream microfluidic channel. In some embodiments, the flow resistance of a part of the upstream channel s is greater than or much greater than the flow resistance of the downstream channel. Further, alternatively, the depth of the upstream channel is less than or much less than the depth of the downstream channel.

In some embodiments, the length of the upstream channel for transporting the disperse phase is greater than or much greater than the length of the downstream microfluidic channel. In some embodiments, the length of the upstream channel for transporting the continuous phase is greater than or much greater than the length of the downstream microfluidic channel. In some embodiments, the cross-sectional area of the upstream channel for transporting the disperse phase is greater than or much greater than the cross-sectional area of the downstream microfluidic channel. In some embodiments, the cross-sectional area of the upstream channel for transporting the continuous phase is greater than or much greater than the cross-sectional area of the downstream microfluidic channel.

In some embodiments, the upstream microfluidic system or channel includes an inlet for introducing liquid. The downstream channel for transporting or receiving upstream droplets includes an outlet.

In some embodiments, when the upstream microfluidic system or channel includes a first portion for transporting the disperse phase liquid and/or a second portion for transporting the continuous phase liquid, the ratio of the flow resistance of the disperse phase to that of the continuous phase of the first portion is equal to or substantially equal to the ratio of the flow rate of the continuous phase to that of the disperse phase.

In some embodiments, the pressure applied to the upstream microfluidic system remains substantially constant or equal. Alternatively, the pressure applied to the microfluidic channel for transporting the continuous phase is the same or substantially the same as the pressure applied to the microfluidic channel for transporting the continuous phase liquid.

In some embodiments, the pressure applied to the downstream microfluidic channel is zero; or the pressure of the downstream microfluidic channel is equal to the external pressure.

In some embodiments, the ratio of the flow rate of the continuous phase to that of the disperse phase in the upstream channel is in the range of 0.001-1000.

In some embodiments, the flow resistance of the disperse phase and the flow resistance of the continuous phase are 1-100000 times greater than the flow resistance of the downstream channel.

In some embodiments, the flow resistance of the disperse phase or the flow resistance of the continuous phase in the upstream channel is much greater than the flow resistance of the liquid in the downstream channel.

In another aspect of the present invention, the present invention provides a microfluidic circuit for generating droplets of uniform size, and manufacturing method and uses thereof.

In one embodiment, the present microfluidic circuit is capable of generating uniform droplets despite fluctuations in pressure.

In one embodiment, the ratio of the flow resistance of the dispersed phase to that of the continuous phase is equal to the ratio of the flow rate of the continuous phase to that of the dispersed phase.

In one embodiment, the present microfluidic circuit comprises two features to achieve the desired ratio of flow resistance and flow rate of the dispersed phase and continuous phase: (a) using a single pressure source which applies identical pressure to the inlets of upstream channels carrying the two phases, and (b) the flow resistance of the dispersed phase and continuous phase is much higher than the flow resistance of the downstream channel so that the flow resistance of the downstream channel becomes negligible.

In one embodiment, the flow resistance of the dispersed phase and continuous phase in the upstream channels is 2-100000 times higher than the flow resistance of the downstream channel.

In one embodiment, the ratio of the flow rate of the continuous phase to the flow rate of the dispersed phase in the upstream channels is in the range of 0.001-1000.

### BRIEF DESCRIPTION OF DRAWINGS

FIG. 1 shows a microfluidic circuit as applied to flow focusing structure for droplet generation according to one embodiment of the present invention, where Q denotes flowrate, R denotes flow resistance and P denotes pressure, and the subscript o, i, c and t respectively denote continuous phase channel, dispersed phase channel, center point at the nozzle, and downstream channel.

FIG. 2A shows a microfluidic circuit according to one embodiment of the present invention. FIG. 2B shows a microfluidic circuit coupled with a chamber for storing droplets generated by the microfluidic circuit.

FIG. 3A shows a microfluidic circuit according to another embodiment of the present invention. FIG. 3B shows a microfluidic circuit coupled with a chamber for storing droplets generated by the microfluidic circuit.

FIG. 4 shows the validation result of one embodiment (FIG. 8) of the present microfluidic circuit (data expressed as mean±SD). The microfluidic circuit was able to produce droplets of uniform diameter when the input pressure changed from 2 psi to 16 psi.

FIG. 5 is an image showing that droplets produced according to one embodiment of the present invention are uniform in size.

FIG. 6 shows different ways of applying pressure according to some embodiments of the present invention.

FIG. 7 shows the application of pressure using a single pressure source according to one embodiment of the present invention. In FIG. 7, there is a piston, by applying an external pressure source to the piston, the chamber in which the piston is located is in communication with the inlet (disperse phase and the continuous phase). When a pressure is applied to the two phases by the movement of piston, the pressure can be applied simply, and the piston seal avoids contamination to the external environment of the two phases. A microfluidic channel is connected to the inlet, and the channel can be arranged as shown in FIGS. 2A-3B and FIG. 8.

FIG. 8 is a structural design of a specific microfluidic device of the experiments of FIGS. 4 and 5 (the material includes silicon wafer and PDMS structure).

### DETAILED DESCRIPTION OF THE INVENTION

Unless otherwise specifically stated, terms of the present inventions are explained in ordinary and common sense.

### Fluidic Communication

Gas communication or liquid communication means that a liquid or gas can flow from one place to another, and the flow process may be guided by passing through some physical structures. The “passing through physical structures” generally means that liquid passively or actively flows to another place by passing though the surface of these physical structures, or the internal space of these structures. “Passively flow” is generally caused by external forces, such as flowing under the action of a syringe pump and a pressure pump. The “flow” herein may be caused by its own action (gravity or pressure), or may be a passive flow, for example, flow under a capillary action. The communication herein does not mean that a liquid or a gas is necessarily present, and in some cases, it only indicates a connection relationship or state between two objects, and if a liquid is present, it can flow from one object to another. The communication here means a connection state of two objects. Conversely, if there is no liquid communication or gas communication between two objects, and liquid is present in or on one object and the liquid cannot flow into or on another object, it is a non-communication state, i.e. non-liquid-communication or non-gas-communication state.

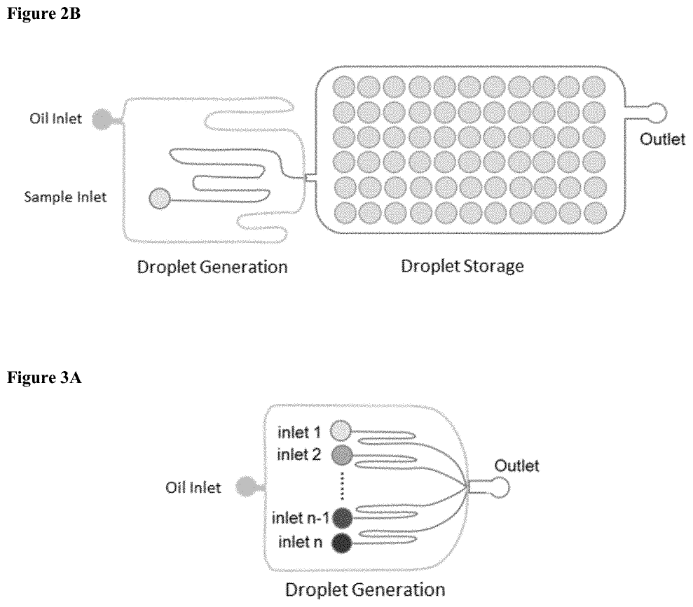

Here, the device of the present invention includes upstream microfluidic conduits or channels that are in liquid or fluidic communication therebetween. The fluid here may be gas and/or liquid, or a mixture of gas and liquid. The liquid can flow in the microfluidic conduit. In a microfluidic system conduit, liquid can flow from one part of the conduit to another part thereof, and the flow can be caused by external pressure or the circulation of capillary forces of the own conduit. For example, in FIG. 2A, a channel for transporting the mobile phase and a channel for transporting the disperse phase are included, and the two channels are converged or collected or contacted at the junction 100 and are in a circulation state at the junction. Droplets can be generated at the junction, and after droplet generation, a downstream channel for transporting droplets, an upstream channel, a channel for generating droplets, or a channel junction, and a downstream channel for transporting droplets are in a fluidic communication state, such that the fluid at the upstream flows to the downstream.

### Upstream and Downstream

The upstream and downstream are determined by the liquid flow direction. Generally, liquid flows from the upstream to the downstream. For example, in FIG. 2A, the oil phase liquid enters a conduit from an inlet and flows from the inlet to the junction 100, the inlet is called as the upstream of the oil phase, and the junction is called as the downstream of the oil phase. For another example, in an outlet channel, the junction can be called as the upstream of the outlet channel and the outlet is downstream of the channel. Alternatively, droplets are generated at the junction and droplets flow from the outlet channel, and at the junction of the droplet generation, the channel for transporting the oil phase or samples can be considered upstream relative to the outlet channel, and for the outlet channel, it is the downstream of the junction. In the present invention, the place where the droplets are generated is the junction that connects the upstream and downstream, the dividing line or the interface. The upstream and downstream are in a fluidic communication state by the place where the droplets are generated. The upstream and downstream are relative concepts. The flow of droplets may be based on own gravity or an external factors, for example, by applying a pressure to the inlet, the liquid in a channel is forced to flow along the channel.

In the present invention, the microfluidic channel or fluid channel also has upstream and downstream. In some embodiments, by taking the place where droplets are generated as a dividing line or a boundary part, a microfluidic channel is divided into two parts: upstream and downstream. The channel for transporting liquid is located at the upstream, for example, the conduits for transporting the disperse phase or/and the mobile phase are located at the upstream of the droplet generating structure, while the conduits for transporting droplets are called the downstream. The droplets flow or move from upstream to the downstream conduits.

### Flow Resistance

Flow resistance means that there is momentum transfer between a fluid and an object that produces relative motion when all fluids are moving, that is, generating a reaction force that hinders the flow, also known as drag force, or frictional resistance. The fluid here is primarily a liquid, or a liquid fluid, such as a solution, an oily substance, or an aqueous solution or a solution containing a chemical component. When liquid of different properties flows in the same channel, the flow resistance is different. Similarly, if the channel property changes, the flow resistance will change even for the same liquid. The channel property herein refers to the material constituting the channel, the channel length, the interior smoothness of channel or channel size, which is also one of the factors affecting the flow resistance. The channel size is generally the height, diameter or cross-sectional area of the channel. The term “liquid” refers to a substance or mixture that becomes a solution or a liquid under a certain temperature. Usually the liquid that flows in a conduit is a liquid substance. Of course, it is not necessarily liquid, it may be a solid that is reasonably wrapped by a liquid substance and such wrapped substance flows in the conduit. In any case, the substance flowing in the conduit is generally subjected to resistance, and the resistance reduces the flow velocity of liquid.

The invention team has found that, the fluid resistance is also a factor affecting the flow of liquid in a microfluidic channel. Particularly, in a microfluidic system for generating droplets, the flow resistance is an important factor affecting droplet formation. In some embodiments, when a microfluidic device is used to generate droplets, the droplet size is also affected by flow resistance. In some embodiments, if the design of a microfluidic channel is changed, which changes the flow resistance of the liquid flowing in the channel, the droplet size may be changed. For example, by changing the flow resistance of the upstream, downstream, or droplet generating structure, the droplet size can be adjusted or changed. In some embodiments, if the flow resistance of the upstream channel for transporting liquid is greater than or much greater than the flow resistance of the downstream channel for transporting droplets, in such case, even if the pressure applied to the upstream liquid changes, the change in pressure will not significantly affect the droplet size, that is, the droplet size is not sensitive to changes in pressure.

The droplet size is not changed significantly or is basically stable within a range, which is particularly important for different testing and applications. The uniform droplet size indicates that the droplet volume is the same, and the liquid content is uniform, thus avoiding the inconsistencies caused by different content among different droplets. For example, in the case where a water phase is wrapped by an oil phase, the water phase may be a liquid sample, or may be a reagent or an aqueous solution of reagent containing some liquid samples, or some aqueous solutions for detection that include reagents necessary for the detection. These water phases have uniform content or volume in a droplet and its content is uniform, so that the initial content or volume of each droplet is basically the same, thus reducing the error caused by difference in volume and content. In addition, in the process of generating droplets especially in a device or method for generating droplets using microfluidics, generally an external pressure is required to promote the flow of liquid, which produces droplets in the flow process. The pressure is much related to droplet size, and a small change in pressure can affect the droplet size, for example, different pressure or pressure change may change or significantly change the droplet size. The present invention discloses one of the key indicators, i.e. flow resistance. By making the upstream flow resistance is much larger than the downstream flow resistance; droplets of uniform size can be generated regardless of the change in pressure. First of all, there is no need to deliberately improve the accuracy of the pressure applied to the channel, reducing the requirements of precision equipment; moreover, it is more convenient and less expensive, since the change in pressure does not affect the droplet size. From another point of view, when there is a manufacturing error of the channel that produces the droplets, these factors are not required to be deliberately considered, as long as the relationship of the flow resistance between the upstream and downstream is considered. By this way, droplets of uniform size can be generated. By slightly adjusting the pressure applied to the upstream channel, droplets of uniform size can be generated, lowering the precision requirement of fluid channel size.

In the prior art, for example, as reported in the literature (Ward, Thomas, et al. “Microfluidic flow focusing: Drop size and scaling in pressure versus flow-rate-driven pumping.” Electrophoresis 26.19 (2005): 3716-3724), the droplet size is affected by the flow rate and pressure. When the flow rate of the disperse phase gradually increases, the continuous flow rate does not change. As the flow rate increases, the droplet size changes significantly; when the pressure applied to the continuous phase is not changed, the pressure applied to the disperse phase is increased gradually, and the shape and size of the droplets are also changed. This indicates that the drop size is affected by many factors in traditional art, for example, the flow rate, and pressure change, etc. Actually, the droplet size is also affected by other factors, for example, the change in the property of microfluidic channel itself may also affect the generation of droplets, especially, affect the change in droplet size. For example, the drop size may be affected by the factors such as materials, cross-sectional area, hydrophilicity or hydrophobicity of the channel inner surface, and surface smoothness, etc. In addition, the property of liquid itself may also affect the changes in flow rate, for example, the viscosity of the liquid, etc. In prior art, one of the reasons for difficulty to achieve generation of droplets of uniform size is that too many factors affect the droplet size, and it is not possible to simply and accurately control the parameters stability of these factors. If it is necessary to control the precision and accuracy of these factors, it will cost much.

In the present invention, the flow resistance is used as an important factor. When the flow resistance is associated with the droplet size, the preparation of droplets of uniform size can be simply realized. Therefore, it becomes simple to consider the factors of flow resistance. In a conventional microfluidic systems or devices for generating droplets, generally the relationship between pressure and flow rate is considered, while the flow resistance of microfluids is considered in the present invention. Generally, in the microfluidic channel generating droplets, liquids of different phases flow in the channel. For example, the liquid of different phases generate droplets at the junction by the balance of the shear pressure or surface tension. After generation, the droplets flow in the channels, which are collected or stored, or directly enter a structure with micropores, allowing droplets to be dispersed in the micropores, for example, one droplet in one micropore. Through experiments, the team of the present invention has found that, by changing the design of microfluidic channels, the droplets have more uniform size, and such uniformity is not changed by the pressure. One of the purposes of changing the design of the microfluidic channels is to change the flow resistance. In some embodiments, the upstream flow resistance is changed relative to the downstream flow resistance, thereby achieving the insensitivity of the droplet size to pressure changes. For example, in some embodiments, by allowing the flow resistance of the microfluidic channel for inputting liquid to be greater than the flow resistance of the channel for transporting droplets, this purpose can be achieved. In some embodiments, the downstream flow resistance is less than or much less than the upstream flow resistance, and the flow resistance of downstream channel for transporting droplets is almost negligible. Alternatively, the upstream flow resistance is greater or much greater than the downstream flow resistance, which could be considered an importance of flow resistance that is recognized in the present invention. Moreover, the relationship of the upstream and downstream flow resistances is also considered, by this way, the droplet generating system or device of the present invention is simpler and more convenient and has a wide range of applications.

In some embodiments, generally the conditions for generating droplets include junction of liquid in a disperse phase and a continuous phase. The disperse phase and continuous phase are relative concepts. A disperse system is a system formed in which one or several substances are highly dispersed in a medium. The dispersed substance is called a disperse phase, and the continuous medium is called a disperse medium or a continuous phase. For example, in a droplet that forms water-in-oil, the water is a disperse phase and the oil is a continuous phase. Conversely, in a droplet that forms oil-in-water, the oil is a disperse phase, and the water is a continuous phase. Of course, the disperse phase may be in a form of solution, for example, an aqueous solution, a colloidal solution, and these solutions contain a substance of any component, or a sample solution, etc. These solutions are generally dispersed in a continuous phase to finally form a droplet. Therefore, in microfluidics, generally a part of the channel is used to transport a disperse phase, such as a sample solution, a colloidal solution, a solution containing a reagent or a mixed liquid of the above solutions, and another part of the channel is used to transport a continuous phase, such as an oily solution. When solutions of two different phases are mixed together, droplets are generated. The present inventors have found that if the flow resistance of each conduit for transporting or conveying different phases is changed relative to the flow resistance of downstream conduit for transporting or conveying droplets, the change in pressure will not substantially affect the change in droplet size, thereby generating droplets of uniform size. In some embodiments, when the flow resistance of the upstream channel for transporting liquid (continuous phase liquid and/or disperse phase) is greater than or much greater than the flow resistance of the downstream channel for transporting droplets, the droplet size will not have a significant change even if the pressure changes significantly. In some embodiments, pressure is applied to the upstream liquid to allow the liquid to flow in the channel at a certain velocity.

In some embodiments, there are more microfluidic channels for transporting disperse phase, and there are more microfluidic circuits for transporting continuous phase. As long as the flow resistance of any one upstream channel is greater than the flow resistance of the downstream channel, the uniformity of liquid size can be improved. In some preferred embodiments, when the flow resistance of any of the upstream channel for transporting fluids (for example, one or more channels for transporting the disperse phase, or one or more channels for transporting the continuous phase) is greater or much greater than the flow resistance of the downstream channel, even if the pressure applied to each upstream channel has a change, it will not significantly affect the change in the droplet size, that is, the drop size is not sensitive to the change in pressure.

In general, the droplet generation and droplet size are a very complex process in microfluidic system and are affected by many factors, for example, the property of the microfluidic channel itself, such as the structure, length, size, depth, and length, and changes in length and depth, etc. In addition, it is also affected by the nature of the liquid flowing in the channel, for example, the change in liquid viscosity, the size of the external pressure source applied to the channel, and the changes in pressure and flow rate between different channels. Here, all factors refer to a combination of various factors in microfluidic flow paths involved in the droplet generation. Thus, the droplet size and generation are affected by a number of variables. As there are too many influencing factors, it is very difficult to make the droplet size almost a constant size or make the microfluidic system to generate droplets of a preset size.

In the present invention, with a creative work, the flow resistance is considered as a factor, combined with the pressure and flow rate, the problem of droplet size variation can be solved, such that the droplet size is not affected by the change in pressure.

In some embodiments, the pressure applied to the disperse phase is equal to or substantially equal to the pressure applied to the continuous phase.

In some embodiments, the flow rate and flow resistance of the upstream disperse phase and the continuous phase meet the following relationship:

$$\frac{{Q}_{o}}{{Q}_{i}} = \frac{{R}_{i}}{{R}_{o}}$$

Where, Qₒ is the flow rate of the upstream channel continuous phase; Ro: flow resistance of upstream channel continuous phase; Qᵢ: flow rate of another upstream channel disperse phase; Rᵢ:flow resistance of another upstream channel disperse phase. At this time, the pressure applied to the continuous phase is equal to that applied to the disperse phase.

In some embodiments, the pressure applied to the disperse phase and the continuous phase is less than

$$\frac{γ {R}_{o} w h}{μ} ,$$

and the pressure applied is equal, that is,

$$P = {P}_{0} = {P}_{i} < \frac{γ {R}_{o} w h}{μ} .$$

Where, P₀ the pressure applied to the continuous phase, Pᵢ is the pressure applied to the disperse phase, γ is the interfacial tension; w and h are the width and height of the continuous phase channel at the nozzle respectively, μ is the viscosity of fluid of the continuous phase. At this time, the pressure change range is broad, for example, in the range of 0-50 psi, and it has no significant effect on the droplet size.

Of course, it can be understood that, in order to satisfy such a relationship, the pressure applied to the disperse phase may be different from the pressure applied to the continuous phase. At this time, the flow resistance of the channel may be changed by setting the structure or size of a conduit for transporting the different phases at the upstream. Although this method is more complicated, it can still achieve the control of droplet size, such that it is not sensitive to change in pressure.

Of course, for the convenience and simplicity of processing, once the upstream channel for transporting liquid is determined, its own properties will not be changed. At this time, it is more important to select substances and pressures of different phases. The main factors that influence the droplet size at this time are pressure, flow rate and flow resistance. Therefore, the pressure is adjusted and flow rate is also adjusted, and the flow rate is also related to the flow resistance. When the pressure is the same, the flow resistance and flow rate of the different phases are in an opposite relationship. For example, when the oil phase (continuous phase) is compared with the water phase (disperse phase), the oil phase has a greater flow resistance and a smaller flow rate than those of the water phase in the same channel. When the flow resistance of the downstream is smaller or much smaller than the flow resistance of the upstream, the flow resistance of the downstream can be negligible when considering the generated droplet size. At this time, the flow resistance of the upstream oil phase multiplied by the flow rate of the oil phase is equal to the flow resistance of the water phase multiplied by the flow rate of the water phase: Rₒ*Qₒ=Qᵢ*Rᵢ; Alternatively, the ratio of the flow resistance of the upstream continuous phase to the flow resistance of the upstream disperse phase is equal to the ratio of the flow rate of the upstream disperse phase to the flow rate of the upstream continuous phase. In order to facilitate to achieve such a manner, the length, size, depth, and nature of the upstream microfluidic channels and the downstream channels can be arbitrarily adjusted to satisfy the relative relationship between the upstream flow resistance and the downstream flow resistance, for example, the length of the upstream channel is larger than the length of the downstream channel, or the cross-sectional area of the upstream channel is smaller than the cross-sectional area of the downstream channel, or the depth of the upstream channel is smaller than the depth of the downstream channel, etc., or the inner wall of the downstream channel is smoother, and inner wall of the upstream channel is thicker, or a combination of the above specific measures. With this design, the downstream flow resistance is small enough relative to the upstream flow resistance, so that it can be negligible. Here, “small enough” means that the upstream flow resistance is greater than or much greater than the downstream flow resistance, rather than there is no downstream flow resistance.

In some embodiments, when adjusting the continuous phase or the disperse phase, or adjusting the flow resistances of the continuous phase and the disperse phase, it is necessary to satisfy the conditions for droplet formation which are determined based on the principle of liquid generation. A person skilled in the art can set the conditions for droplet formation according to the disclosed art. However, it is not easy for conventional techniques to solve the generation of droplets of relatively fixed size. As stated in this application, there are too many factors affecting the droplet size and these factors interact with each other. The present inventors have found that, when the upstream flow resistance is greater than the downstream flow resistance in a microfluidics, the droplet size is less affected by the change in pressure, thereby allowing the droplet size not to be affected by the change in pressure or reducing the effect of pressure on the droplet size.

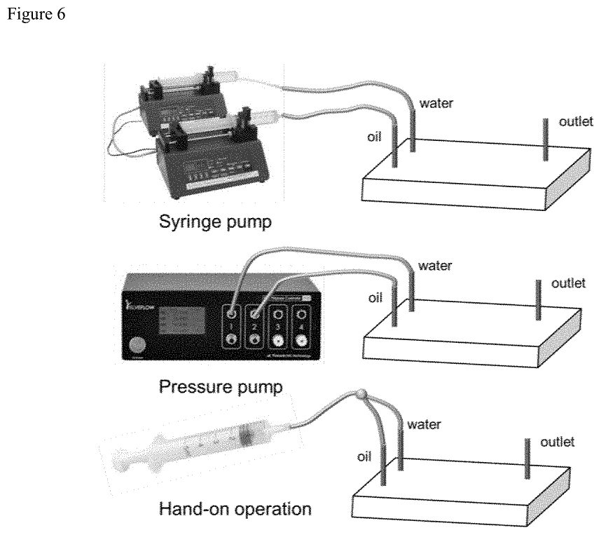

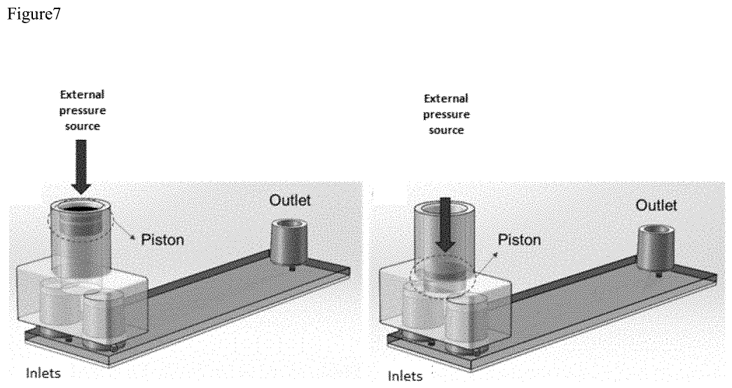

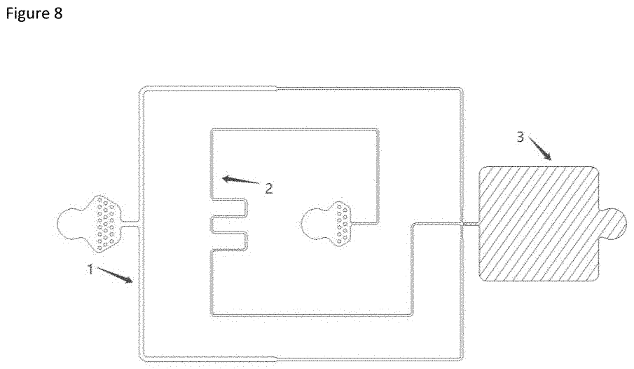

Under such conditions, the change in pressure will not change the droplet size significantly. For example, as shown in FIGS. 5-7, the droplet generating device designed in FIG. 7 is used, in which the channel 1 is a continuous phase, for example an oil phase, and the channel 2 is a disperse phase, for example a water phase, or an aqueous solution. Channel 3 is an outlet located at downstream. Wherein, the width (W) of the channel in the channel 1 is 150 μm from the inlet, the total length is 19.3 mm, and the depth is 25 μm; the flow channel width in the flow channel 2 is 60 μm, the total length is 30 mm, and the depth is 25 μm. The region 3 is a chamber having a length of 3900 μm, a width of 3700 μm and a depth of 90 μm. The microfluidic chip is etched on the silicon wafers and boned on glass sheets. With such a setting, the flow resistance of any upstream channel is greater than or much greater than the downstream flow resistance, as long as the droplet formation conditions are met and the pressures applied to channels 1 and 2 vary within the range of 0-16 psi, the droplet size will be within 3 μm, for example, the results as shown in FIGS. 5 and 6.

The changes in pressure mean that the pressure applied to the liquid of the channel 1 and the channel 2 is the same, but the pressure varies, for example, the pressure applied for the first time is 2 psi, and the pressure applied for the second time is 10 psi, which is different from that of the first time, but the droplet size is still within 3 μm. The changes in pressure also mean that the pressure applied to the channel 1 and channel 2 is different, but the pressure varies, for example, the pressure applied to the channel 1 is 2 psi and that applied to the channel 2 is 4 psi for the first time, and the pressure applied to the channel 1 is 4 psi and that applied to the channel 2 is 6 psi for the second time. In such cases, although the pressures change, the resulting droplet size remains within a relatively stable range. Of course, the change in pressure can also be understood as different pressures applied to different phases each time, for example, the pressure applied to the continuous phase is 2 psi and the pressure applied to the disperse phase is 1.5 psi for the first time.

A person having ordinary skill in the art will readily appreciate that the pressure change and value are based on different liquid properties and can be freely altered. This greatly facilitates the generation of droplets. There is no need to strictly control the consistency of the pressure, or precisely adjust the pressure each time. As long as the pressure is changed within a certain range, it will not have a substantial impact on the droplet size, and the droplet size will basically remain in a stable range. These methods will be described in details below.

The present invention provides a microfluidic circuit for generating uniform droplets, and manufacturing method and uses thereof.

The present invention provides a microfluidic circuit for generating droplets of uniform size, and manufacturing method and uses thereof.

In one embodiment, the present microfluidic circuit is capable of generating uniform droplets despite fluctuations in pressure.

In one embodiment, the ratio of the flow resistance of the dispersed phase to that of the continuous phase is equal to the ratio of the flow rate of the continuous phase to that of the dispersed phase.

In one embodiment, the present microfluidic circuit comprises two features to achieve the desired ratio of flow resistance and flow rate of the dispersed phase and continuous phase: (a) using a single pressure source which applies identical pressure to the inlets of upstream channels carrying the two phases, and (b) the flow resistance of the dispersed phase and continuous phase is much higher than the flow resistance of the downstream channel so that the flow resistance of the downstream channel becomes negligible.

In one embodiment, the flow resistance of the dispersed phase and continuous phase in the upstream channels is 2-100,000 times higher than the flow resistance of the downstream channel.

In one embodiment, the ratio of the flow rate of the continuous phase to the flow rate of the dispersed phase in the upstream channels is in the range of 0.001-1000.

In one embodiment, the present invention produces droplets of uniform size with pressure fluctuations up to 20 psi.

This invention provides a method of designing a pressure insensitive microfluidic circuit that enables a robust droplet generation. As described herein, the present microfluidic circuit is configured to minimize the effect of fluctuations in pressure in the droplet generation system on the droplet generation process, therefore is able to operate stably and generate droplets of uniform size without the need of complex setup for tightly controlling the pressure. As compared to conventional approach for droplet generation, the present microfluidic circuit is less sensitive to pressure fluctuations and is able to generate droplets consistently and efficiently. The present microfluidic circuit can be applied to conventional shear-flow based droplet generating systems and be integrated into various machines or systems for a wide range of applications.

In one embodiment, the present microfluidic circuit can produce uniform droplets not withstanding a pressure fluctuation in the range of 0-20 psi (as compared to 1 psi in the interfacial-tension based approach). The observed range of permissible pressure variations is wide and is neither actually achieved by existing approaches nor contemplated in literature or patents. Moreover, the present design of microfluidic circuit can be coupled with any conventional flow focusing and T junction configurations, resulting in devices that produce uniform droplets in a robust while much simpler manner. The present invention facilitates hands-on operation and would be especially favorable for biological or chemical laboratories in where complicated and expensive microfluidic setup for droplet generation are generally not affordable or available. This invention helps to propel the wide applicability of droplet microfluidics for any laboratories without the specialty in microfluidics and can further improve the performance of microfluidic-based assays such as accuracy and consistency by producing more uniform droplets. Apart from its pressure insensitivity, the present invention is better than conventional shear-flow based approach since it only requires one pressure source rather than two, and therefore does not require complex pressure circuit.

The present invention is also superior to conventional interfacial tension driven systems in which bubbles are often trapped in the channels and subsequently interfere with the process of droplet generation. Occurrence of bubbles trapped during droplet generation in the present invention is minimal since the flow rate of both continuous and dispersed phase is relatively high during the process and bubbles generated (if any) can be flushed away during the priming process when the phase fluids are introduced into the device and when the phase fluids are removed from the outlet.

Overall, with its robustness and high versatility, the present microfluidic circuit can be coupled with a wide range of microfluidic system and widely applied in laboratories and industries to develop point-of-care products and other chemical and biological assay using droplet microfluidics.

### Design of Microfluidic Circuit

In one embodiment, the present invention provides a method of designing or preparing a microfluidic circuit for droplet generation.

The method includes setting a microfluidic channel. The circuit includes a microfluidic channel structure for droplet generation. The structure divides the microfluidic circuit into upstream and downstream. The upstream is use for transporting liquid for droplet generation, for example, a disperse phase or a continuous phase, and the downstream is used for transporting or conveying or dispersing droplets, such that the upstream flow resistance is greater than the downstream flow resistance, or the upstream flow resistance is much larger than the downstream flow resistance.

In one embodiment, the present invention provides a microfluidic circuit for droplet generation prepared by the method described herein.

In one embodiment, the present microfluidic circuit is designed based on a hydrodynamic flow resistance circuit model. In one embodiment, the present microfluidic circuit is configured to tolerate fluctuations in pressure in the microfluidic channel, thereby enabling generation of uniform droplets within a range of pressure.

In one embodiment, the present microfluidic circuit comprises one or more inlets, one or more channels, a chamber, one nozzle, and one or more outlets. One or more filters may also be provided at the inlets to remove impurities or particulars which may block the channels.

In one embodiment, the chamber is designed for droplet storage to collect droplets generated from the droplet generating device. In one embodiment where a droplet storage chamber is not used, droplets can be directly collected from the outlet. U.S. Provisional Application No. 62/723,455 describes droplet storage chambers of various forms. The contents of said Application are hereby incorporated by reference in their entirety into this application. Chambers which have similar configurations yet serve purposes other than droplets storage can also be used in connection with this invention.

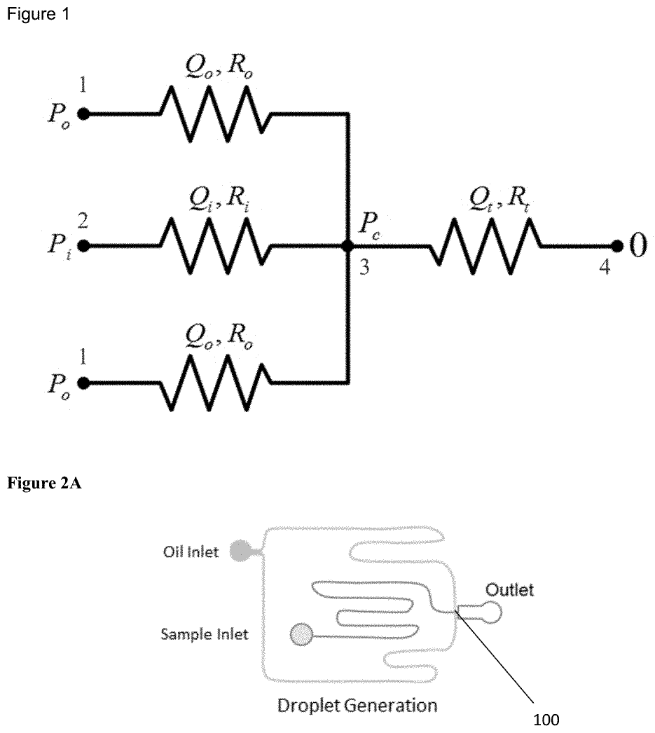

FIG. 1 is a simplified schematic of the present microfluidic circuit as applied to a flow focusing structure for droplet generation. However, it should be noted that the present design of microfluidic circuit can be applied to any shear based droplet-generating structure such as T-junction and co-flow structure based on the same principles.

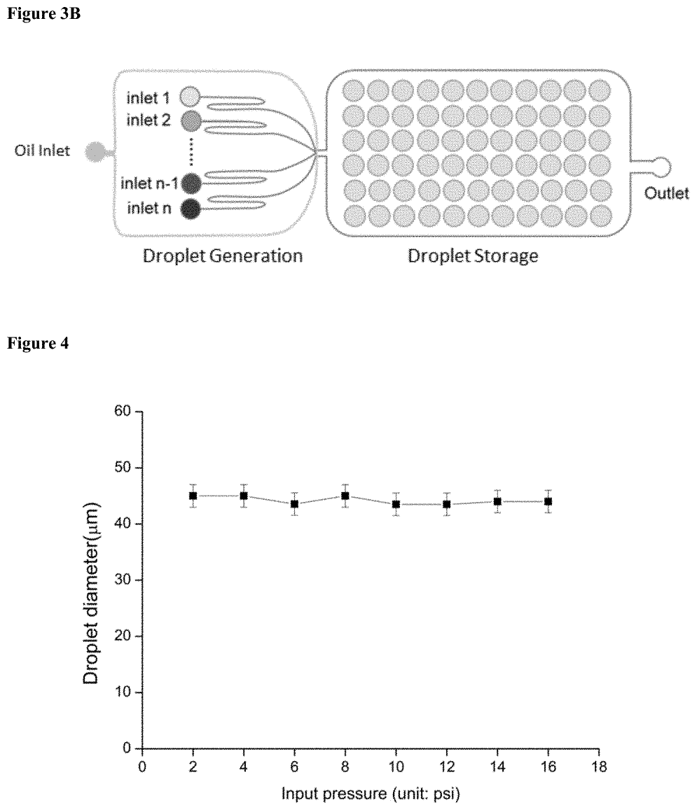

As illustrated in FIG. 1, point 1 is the inlet for continuous phase, point 2 is the inlet for dispersed phase, point 3 is the nozzle where droplets are formed, and point 4 is the outlet. The pressure at the outlet is zero. FIGS. 2A-2B show two embodiments where the microfluidic circuit comprises one inlet for oil and one inlet for sample, while FIGS. 3A-3B show two embodiments where the microfluidic circuit comprises one inlet for oil and a plurality of inlets (1 to n) for different types of liquids.

In some embodiments, in order to make the flow resistance of the upstream channel higher than or much higher than the downstream flow resistance, the length, width or depth of the upstream microfluidic channel may be changed relative to the downstream channel for transporting droplets, for example, the length of the channels of the continuous phase or/and the disperse phase is greater than or much greater than the length of the downstream channel for transporting droplets, or the width of the channels of the continuous phase or/and the disperse phase is less than or much less than the width of the downstream channel for transporting droplets; or the depth of the channels of the continuous phase or/and the disperse phase is less than or much less than the depth of the downstream channel for transporting droplets; alternatively, the cross-sectional area of the channels of the continuous phase or/and the disperse phase is less than or much less than the cross-sectional area of the downstream channel for transporting droplets. Such changes may be made for a part or a whole of the upstream channel, or a part of a whole of the downstream channel. Now, the mechanism by which the present invention can achieve a uniform droplet size that is insensitive to pressure changes will be described based on FIG. 1. The description and implementation of this mechanism are merely illustrative of one preferred embodiment of the present invention and do not limit the scope of the present invention.

FIG. 1 is a schematic diagram of a typical droplet structure for generating droplets, where, Q denotes flow rate, R denotes flow resistance and P denotes pressure, and the subscripts o, i, c and t respectively denote continuous phase channel, dispersed phase channel, center point at the nozzle (where the droplets are generated), and downstream oil phase channel for transporting droplets; wherein,

Pₒ: pressure applied on the continuous phase;

Qₒ: flow rate of the continuous phase in an upstream channel;

Rₒ: flow resistance of the continuous phase in an upstream channel;

Pᵢ: pressure applied on the dispersed phase;

Qᵢ: flow rate of the dispersed phase in another upstream channel;

Rᵢ: flow resistance of the dispersed phase in another upstream channel; P_{c}: local pressure at the center point of the nozzle; Qₜ: flow rate of the fluid in the downstream channel after droplet formation; Rₜ: flow resistance of the fluid in the downstream channel after droplet formation.

If the change of the properties of the fluidic circuit itself is not considered, once the fluid structure design is completed, the droplet size is basically determined, and the liquid used for the disperse phase and continuous phase is basically determined. The flow rate in each channel is calculated according to the following formula:

$$\begin{matrix}{Q}_{i} = \frac{( {R}_{o} + 2 {R}_{t} ) {P}_{i} - 2 {R}_{t} {P}_{o}}{( {R}_{o} {R}_{t} + {R}_{i} {R}_{o} + 2 {R}_{i} {R}_{t} )} & ( 1 ) \\ {Q}_{o} = \frac{( {R}_{i} + {R}_{t} ) {P}_{o} - 2 {R}_{t} {P}_{i}}{( {R}_{o} {R}_{t} + {R}_{i} {R}_{o} + 2 {R}_{i} {R}_{t} )} & ( 2 )\end{matrix}$$

As shown form the above formula, the flow rate, pressure, flow resistance of the upstream and the downstream, and the pressure and flow resistance between the two phases interact with each other.

Dividing equation (2) by equation (1):

$${Q}_{0} / {Q}_{i} = \frac{( {R}_{i} + {R}_{t} ) {P}_{o} - {R}_{t} {P}_{i}}{( {R}_{o} + 2 {R}_{t} ) {P}_{i} - 2 {R}_{t} {P}_{o}} \qquad ( 3.0 )$$

The ratio of the flow rate is correlated to the droplet size. The correlation means that the droplet size is correlated to the flow rate ratio. The correlation can be at least understood as impact of flow rate on droplet size. If the flow rate ratio remains unchanged, the fluctuation of droplet size can be reduced and maintained at a relatively stable state. By simplification, it is Equation 3.1, in which the ratio of the flow rate of the continuous phase to that of disperse phase is related to the upstream and downstream flow resistances and the applied pressures. In Equation 3.0, if the upstream flow resistance is greater than the downstream flow resistance, the flow rate is mainly influenced by the flow resistance of the upstream continuous phase and the disperse phase, reducing the influence of flow resistance of the downstream channel for transporting droplets. Further, in addition, if the upstream flow resistance is much greater than the downstream flow resistance, Rₜ is almost negligible with respect to Rᵢ and Rₒ, and the influence of Rₜ on the flow rate is almost negligible, for example, when it is 0, the formula is Equation 3.2:

$$\begin{matrix}{Q}_{o} / {Q}_{i} = \frac{{R}_{i} {P}_{o} + {R}_{t} {P}_{o} - {R}_{t} {P}_{i}}{{R}_{o} {P}_{i} + 2 {R}_{t} {P}_{i} - 2 {R}_{t} {P}_{o}} & ( 3.1 ) \\ \frac{{Q}_{o}}{{Q}_{i}} = \frac{{R}_{i} {P}_{o}}{{R}_{o} {P}_{i}} & ( 3.2 )\end{matrix}$$

As seen from Equation 3.2, the ratio of the flow rate is inversely proportional to the flow resistance and proportional to the pressure. If the ratio of the flow resistance remains unchanged, the pressure is proportional to the flow rate. If the ratio of the pressure is adjusted, the flow rate ratio is changed. Generally, when the liquid properties of the continuous phase and disperse phase are determined, the properties of the microfluids themselves are determined, and the ratio of flow resistance is a fixed value. Of course, in order to keep the ratio of the flow rate constant, the ratio of the flow resistance and the ratio of pressure between the two phases can be adjusted. For example, if the flow resistance Rᵢ of the disperse phase increases and the flow resistance of the continuous phase remains unchanged, it is necessary to increase the pressure of the continuous phase, to keep the flow rate ratio unchanged. Alternatively, in order to make the ratio of the flow rate constant, when the ratio of the flow resistance is not equal to the ratio of the flow rate, it is required to adjust the ratio of the pressure of the disperse phase to that of the continuous phase, to maintain the flow rate ratio unchanged. The ratio of the flow resistance can be adjusted by any of the foregoing methods, for example, adjusted by the length and depth of the channel, smoothness of the inner wall of conduit, materials and width, etc. Of course, it can also be adjusted by the properties of the liquid of the disperse phase and the continuous phase, for example, the concentration, addition of additional reagent components, to change the dispersibility and viscosity of the continuous phase. Of course, the ratio can be changed by adjusting all these factors, to keep the flow rate ratio unchanged. Additionally, the change of any one of parameters in Equation 3.2 will affect the change of the ratio. As shown from Equation 3.2, change to any parameter will affect the droplet size, but for the actual design and product, the ratio of flow resistance can be basically determined, or, once the microfluidic structure is determined, the factors that change the flow resistance caused by microfluid are basically determined, then adjustment of the pressure and flow rate can keep the flow rate ratio unchanged and the droplets are maintained a uniform size.

In some preferred modes, if the pressure applied to the continuous phase and the disperse phase is equal, and if P₀=Pᵢ, the Equation (3.2) becomes Equation (4):

$$\frac{{Q}_{o}}{{Q}_{i}} = \frac{{R}_{i}}{{R}_{o}} \qquad ( 4 )$$

At this time, the ratio of the flow resistance of the disperse phase to that of the continuous phase is almost equal to the ratio of the flow ratio of the continuous phase to that of the disperse phase, that is, Equations (1)-(4) indicate that, when the pressure applied to the continuous phase fluid inlet is the same as the pressure applied to the disperse phase fluid inlet (P₀=Pᵢ) and the flow resistance of the two phases is much higher than the flow resistance of the downstream channel (Rᵢ, Rₒ>>Rₜ), the ratio of the flow resistance of the disperse phase to that of the continuous phase is almost equal to the flow rate ratio of the continuous phase to that of the disperse phase.

The flow rate ratio is related to the droplet size. According to the above equation, the ratio of flow resistance is also related to the droplet size. When the pressure is equal, if the flow rate ratio remains the same, the effect of the downstream flow resistance on the flow rate is eliminated, then the flow rate ratio is equal to the flow resistance ratio. At this time, even if the pressures applied to the continuous phase and the disperse phase has changed, the droplet size will not be affected as long as the pressures of them are equal. For example, when the multiple pressures applied to the disperse phase and the continuous phase are 1 psi, 1.5 psi, 2 psi, 3 psi, 4 psi, 5 psi, 6 psi, 7 psi, 20 psi, 30 psi, respectively, the change in flow rate is not related to the absolute pressure applied to the two phases, but only related to their ratio. Therefore, the droplet size is not related to the absolute change in pressure, but only related to the relative change.

As discussed, shear-based droplet generation is affected by flow rates and fluid properties of the two phases, and nozzle geometry of the droplet generating structure (e.g. T-junction and flow-focusing). Since the geometric feature of the droplet generating structure is fixed, the resulting droplet size (D) is mostly determined by the flow rate ratio (D ∝Qₒ/Qᵢ). Since Qₒ/Qᵢ is equal to Rᵢ/Rₒ (Equation (4)) which is determined by the fluid viscosity and geometry of the channel and is independent of the operation process, the pressure variation would not affect the resulting droplet size.

The combination of the geometry of the channel and the properties of the liquid itself causes the ratio of the flow resistance of the upstream continuous phase to that of the disperse phase, in such case, the geometric feature of the downstream channel and the properties of downstream droplet itself are almost not considered. The reason is that the present invention almost eliminates the influence of the geometry of the downstream channel on the flow rate in the whole system, and the downstream flow resistance is almost negligible relative to the upstream flow resistance. It can be understood that the greater the ratio of the upstream flow resistance to the downstream flow resistance, the smaller the influence of the pressure change. If the downstream flow resistance is almost zero and much less than the upstream flow resistance, the system can withstand a wide range of pressure change for the resulting droplet size.

This gives a theoretical explanation on setting a flow resistance relationship of the upstream and downstream in the present invention, to make the droplet size insensitive to the change in pressure.

In some embodiments, pressure to be applied (P) to the inlets is

$$P = {P}_{0} = {P}_{i} < \frac{γ {R}_{o} w h}{μ} \qquad ( 5 )$$

where

γ is the interfacial tension;

w and h are the width and height of the channel at the nozzle respectively; and

μ is the viscosity of fluid (the viscosity of fluid of the continuous phase).

Thus, when the pressure is equal to satisfy such a quantitative relationship, the applied pressure has a range of variation within which the droplet size is not related to the change in pressure. The pressure range is established only when the flow resistance of the upstream channel is much larger than the downstream flow resistance. This is only a preferred embodiment. If it is not within this range, the range of pressure changes may be smaller, but it is still relatively insensitive to the droplet size. For example, when the pressure is in the range greater than

$$\frac{γ {R}_{o} w h}{μ} ,$$

the droplet size can also be not sensitive to the pressure, but other parameters, such as the size of the microfluidic droplet channel, or other conditions that may affect the flow rate ratio, may need to be changed, as described in the Equations 3.0-3.2.

The size of droplets generated by a droplet generation system is proportional to (Qᵢ/Qₒ)^{0.25} when capillary number (Ca) is smaller than 1. Capillary number (Ca) is defined as

$$\frac{μ V}{γ}$$

(where μ is the viscosity of fluid constituting the continuous phase, Vis the flow velocity, γ is the interfacial tension), it represents the relative effects of viscosity of fluid and interfacial tension on droplet generation. Higher capillary number means shear force is more dominant in the process of droplet formation. Smaller capillary number means interfacial tension is more dominant when droplets are formed.

Therefore, in one preferred embodiment of the present invention, when Rᵢ, Rₒ>>Rₜ, and

$$P = {P}_{0} = {P}_{i} < \frac{γ {R}_{o} w h}{μ} ,$$

the capillary number will be smaller than 1 and the droplet size will be proportional to Qₒ/Qᵢ. The present invention envisions that by using a much higher flow resistance of the two phases as compared to the flow resistance of the downstream channel (Rᵢ, Rₒ>>Rₜ) and applying an identical pressure to the inlets of the two phases at a level small than

$$\frac{γ {R}_{o} w h}{μ} ,$$

the capillary number can be kept below one, so that a proportional relationship between the size of droplets and Qₒ/Qᵢ can be achieved. Furthermore, when Rᵢ,Rₒ>>Rₜ, Qₒ/Qᵢ is equal to Rᵢ/Rₒ which is independent of the operation process, the droplet generation process will be independent of pressure fluctuations.

Overall, the present invention provides for the first time a strategic design of microfluidic circuit which enables a robust production of droplets of uniform sizes despite fluctuations in pressure in the system, the present design comprises applying identical pressure to the inlet of the continuous phase fluid and the inlet of the dispersed phase fluid (where

$$P = {P}_{0} = {P}_{i} < \frac{γ {R}_{o} wh}{μ} )$$

and controlling the flow resistance of the two phases at values which are much higher than the flow resistance of the downstream channel (Rᵢ, Rₒ>>Rₜ). As such, one single pressure source is sufficient for droplet generation and the problems of pressure fluctuations observed in conventional shear-based system can be overcome.

### Operating Conditions

### Pressure

In some embodiments, when the pressure variation of Equation 3.2 is satisfied, droplets of relatively stable size can be obtained, so the pressures applied to the continuous phase and the disperse phase as well as the pressure applied to the downstream for transporting droplets may be varied, and such variations are still established when the upstream flow resistance is greater than or much greater than the downstream flow resistance. Therefore, the pressure applied to the continuous phase and the mobile phase is not necessarily equal each time, and some differences are also feasible.

In one embodiment, the present microfluidic circuit operates under a pressure which is expressed by this formula

$$P = {P}_{0} = {P}_{i} < \frac{γ {R}_{o} wh}{μ} .$$

In one embodiment, the present microfluidic circuit operates under a pressure in the range of 0-50 psi.

In one embodiment, pressure is applied to the inlets through an external pump of any kind that can be used for a microfluidic flow system such as a syringe pump or a pressure pump. In one embodiment, pressure is applied manually by connecting a syringe to the inlets and pressing the syringe plunger. Hence, the present invention can be adapted to standard operations using standard pressure units as well as handy operations using simple and less costly setup. FIG. 6 is a schematic diagram showing the application of pressure according to some embodiments of the present invention.

In one embodiment, pressure is applied to the inlets according to FIG. 7. A hollow structure comprising a piston is provided to connect the external pressure source to the two inlets. Pressure is firstly applied to the hollow structure through its upper opening (as shown by the arrow in the left panel). The piston is then forced to move down (as shown by the arrow in the right panel) and hence compresses the air inside the hollow structure until an equilibrium is obtained (i.e. pressure inside the hollow structure is the same as the external pressure). As such, identical pressure can be applied to the two inlets simultaneously using one single pressure source.

In one embodiment, pressure of the present microfluidic circuit is monitored through the external pressure source. In another embodiment, the present microfluidic circuit comprises sensor for measuring and monitoring pressure at one or more locations within the microfluidic circuit.

In one embodiment, the present microfluidic circuit produces droplets of uniform sizes despite a change in pressure in the droplet generating system. In one embodiment, the present microfluidic circuit produces uniform droplets when the pressure varies within 0-20 psi. In one embodiment, the present microfluidic circuit produces uniform droplets when the pressure varies within 1-5 psi. In one embodiment, the present microfluidic circuit produces uniform droplets when the pressure varies within 6-10 psi. In another embodiment, the present microfluidic circuit produces uniform droplets when the pressure varies within 11-15 psi. In yet another embodiment, the present microfluidic circuit produces uniform droplets when the pressure varies within 16-20 psi.

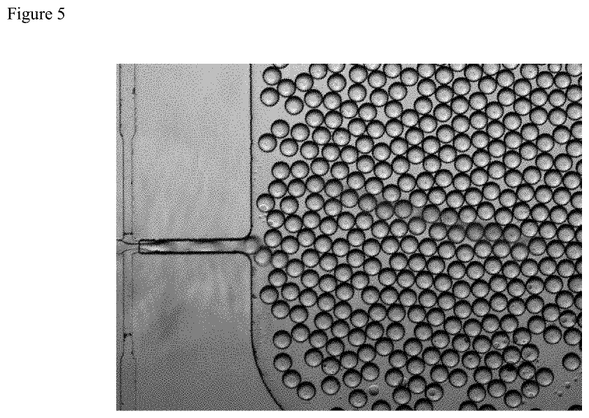

Example 1 describes a test which validated that the present microfluidic circuit is able to produce uniform droplets despite variations in pressure. As seen in FIG. 4, the diameter of droplets generated by the present microfluidic circuit did not change significantly as the pressure applied to the inlet changed from 2 psi to 16 psi.

FIG. 5 shows droplets produced by the present microfluidic circuit are uniform in size.

### Flow Rate and Flow Resistance

In one embodiment, the present microfluidic circuit operates at a flow rate in the range of 0.01 μL-1 L/hr. In one embodiment, the flow rate of the continuous phase is 0.01 μL-1 L/hr. In one embodiment, the flow rate of the dispersed phase is 0.01 μL-1 L/hr. In one embodiment, the ratio of the flow rate of the continuous phase to the flow rate of the dispersed phase (Qₒ/Qᵢ) is in the range of 0.001-1000. In yet another embodiment where a flow focusing structure is used, the flow rate ratio (Qₒ/Qᵢ) is in the range of 0.5-40 [10].

In one embodiment, flow rate is controlled by a pressure pump or a syringe pump.

In one embodiment, the flow resistance of channels carrying the dispersed phase and continuous phase are higher than that of the downstream channel (i.e., Rᵢ, Rₒ>>Rₜ). In one embodiment, flow resistance of the dispersed phase and continuous phase are higher than the flow resistance of the downstream channel by 2 to 100,000 times. In one embodiment, flow resistance of the dispersed phase and continuous phase are higher than the flow resistance of the downstream channel by 2-1000 times. In one embodiment, flow resistance of the dispersed phase and continuous phase are higher than the flow resistance of the downstream channel by 5-50 times, 10-100 times, 25-250 times, 150-300 times, 250-400 times, 350-500 times, 450-600, 650-800 times, 750-900 times, or 850-1000 times.

In one embodiment, the flow resistance (R) is determined by the dimensions of the channel and viscosity of the fluid as summarized below:

For channel of circular cross-section:

$$R = \frac{8 μ l}{π {r}^{4}} \qquad ( 6 )$$

Where, l is the total length of the channel and r is the radius of the channel, μ is viscosity of the fluid.

For channel of rectangular cross-section:

$$R \approx \frac{12 μ l}{{wh}^{3} ( 1 - \frac{0.630 h}{w} )} \qquad ( 7 )$$

Where, l is the total length of the channel, w is the width, h is the height of the channel and μ is viscosity of the fluid, provided that h<w.

One of ordinary skill art would be able to adjust the flow rate and flow resistance according to the present disclosure and common knowledge in the art.

Therefore, by configuring the present microfluidic circuit design in a fashion that the ratio of flow resistance of dispersed phase to continuous phase Rᵢ/Rₒ is equal to the ratio of flow rate of continuous phase to that of the dispersed phase Qₒ/Qᵢ and applying a suitable pressure

$$( < \frac{γ {R}_{o} wh}{μ} )$$

to keep capillary number (Ca) smaller than 1, the process of droplet generation become less sensitive to pressure and hence produces uniform droplets despite variations in pressure of the system. The configuration requires a relatively simple setup since a tight control of pressure is not necessary and therefore permits a robust production of droplet in a more cost-effective and convenient manner.

It should be noted that, the flow rate in the present invention refers to the mass or volume of liquid passing through the microfluidic channel for a period of time. Here, the flow rate may be mean flow velocity multiplied by the cross-sectional area of the microfluidic channel. In microfluidics, especially in microfluidic systems for generating droplets, the flow velocity of a liquid in a microfluidic channel is not uniform across a cross-section, and the flow velocity near the wall and center of the microchannel is not the same. Therefore, in the present application, the generation of droplets is determined by the flow rate ratio. In a microfluidic channel, especially in the microfluidics for droplet generation, the flow velocity generally refers to the mean flow velocity. The flow rate divided by the cross-sectional area of the channel is the mean flow velocity. According to these definitions, the flow rate of the present application has a correlation with the flow velocity. When the cross-sectional area of the channel is determined, it can be considered that the flow rate is related to the flow velocity.

### Designing a Microfluidic Circuit Using the Present Invention

This section provides an example of designing a microfluidic circuit for droplet generation which is insensitive to fluctuations in pressure according to one embodiment of this invention.

Flow rate ratio of the dispersed phase and that of the continuous phase of 0.25 (i.e., Qᵢ/Qₒ=0.25) is selected, the ratio of flow resistance of continuous to that of the dispersed phase is therefore 0.25 (i.e., Rₒ/Rᵢ=0.25) when same pressure is applied to the inlets of the dispersed phase and the continuous phase according to Equations (1)-(4).

A microfluidic circuit can then be designed based on Equations (6) or (7), where fluid viscosity (μ) of each phase can be measured by a viscometer. For a particular design of microfluidic circuit, it is expected that fluids having a fluid viscosity with a slight variation (e.g. up to 5%) will not cause substantial changes to the prescribed flow resistance ratio.

Dimensions of the upstream and downstream channels (length (l), width (w) and height (h) for rectangular channel or radius (r) for circular channel) will be configured such that the flow resistance of the upstream channels will be much higher than the flow resistance of the downstream channel (i.e., Rᵢ, Rₒ>>Rₜ).

Pressure to be applied to the inlets is then calculated according to

$$P = {P}_{0} = {P}_{i} < \frac{γ {R}_{o} wh}{μ} ,$$

where interfacial tension (γ) is measured by the pendant drop method.

In one embodiment, the following parameters are used:

l: 0-1 m

w: 0-5 mm

h: 0-5 mm

μ: 0-5 Ns/m2

γ: 0-1 N/m

### Droplet Generation Device and Droplet Generation

A person having ordinary skill in the art would readily appreciate that the present invention can be applied for designing a variety of droplet generating device of different types and forms. P. Zhu and L. Wang (2017) [2] describe a few technologies for droplet generations, the contents of which are hereby incorporated by reference in their entirety into this application.

In one embodiment, droplet generating device can be of any structure or system that is capable of partitioning a liquid sample into a large quantity of droplets while compatible with the microfluidic circuit described herein.

In one embodiment, the present invention is used for designing a shear-based droplet generating device which utilizes shear stress to pinch the fluid thread into small droplets. In one embodiment, shear-based droplet generating devices include but are not limited to devices comprising a cross-flowing structure, a co-flowing structure and a flow focusing structure.

In one embodiment, the present invention is used for designing a droplet generating device which is a hybrid of the shear-based system and the interfacial tension-based system. In one embodiment, the droplet generating devices include but are not limited to devices comprising a structure of T-junction combining with step emulsion and a microchannel emulsification structure, or a flow-focusing structure combining with step emulsion and a microchannel emulsification structure.

In one embodiment, the present invention is related to a droplet generating device which comprises a crossflowing structure which permits the continuous phase and dispersed phase to intersect at a certain angle θ. In one embodiment, the present droplet generator comprises a structure of T-junction, Y-junction, double T-junction, K-junction or V-junction.

In one embodiment, the present invention is related to a droplet generating device which comprises a co-flowing structure in which the dispersed fluid thread is punched off by the surrounding flow continuous phase. In one embodiment, the co-flowing structure is a 2D planar co-flowing structure.

In one embodiment, the present invention is related to a droplet generating device which comprises a flow focusing structure which constricts the flow to strength the focusing effect. In one embodiment, the flow focusing structure is a 2D planar flow focusing structure.

In one embodiment, droplets are generated as emulsion droplets and are not limited to a particular type of emulsion. In one embodiment, emulsions include but are not limited to oil-in-water, water-in-oil and water-oil-water double emulsion.

In one embodiment where oil-in-water emulsion is used to generate oil droplets, water is the continuous phase while oil is dispersed phase. In one embodiment where water-in-oil emulsion is used to generate water droplets, oil is the continuous phase while water is the dispersed phase.

In one embodiment where water droplets are generated, components or parts of the droplet generating device which is configured for droplet generation have a hydrophilic surface.

In one embodiment where oil droplets are generated, components or parts of the droplet generating device which are configured for droplet generation have a hydrophobic surface. It can be accomplished by chemical surface coating by conjugating hydrophobic groups on the surface of the components or parts. In one embodiment, a surfactant such as Span 80, Tween 20 or Abil EM90, perfluoropolyether-polyethylenoxide-perfluoropolyether triblock copolymer (PFPE-PEG-PFPE) is added to the oil phase or water phase to avoid droplet coalescence or prevent molecules such as enzymes, DNA or RNA from adhering to the solid surface or water-oil interface.

In one embodiment, oil and surfactant are used for droplet generation. In one embodiment, the ratio of surfactant to oil is 1-5% (by weight). In one embodiment, oil to be used for droplet generations includes but is not limited to mineral oil, silicon oil, fluorinated oil, hexadecane and vegetable oil. In one embodiment, surfactant to be used includes but is not limited to Span 80, Tween 20/80, ABIL EM 90 and phospholipids, PFPE-PEG-PFPE. Surfactants that can be used in droplet-based microfluidics have been described by B aret, Jean-Christophe (2012) [11], the content of which is hereby incorporated by reference in its entirety into this application.

### Application of the Present Microfluidic Circuit

With its robustness and high versatility, the present invention can be coupled with a wide range of microfluidic system and widely applied in laboratories and industries to develop point-of-care products and other chemical and biological assay using droplet microfluidics.

For example, the present invention can be used for DNA, protein, exosome detection [12-14], RNA sequencing sample preparation [15] or immunotherapy engineering [16].

In one embodiment, the present invention provides a method for generating droplets of uniform size, the method comprises the steps of.
a) introducing a first liquid under pressure into at least one first upstream channel in a microfluidic circuit to form a continuous phase, and introducing at least one second liquid under pressure into at least one second upstream channel in the microfluidic circuit to form a dispersed phase, the upstream channels merge at a nozzle to generate droplets, and a downstream channel transports said droplets to an outlet;
b) controlling the flow rate of the continuous phase and dispersed phase, wherein the ratio of the flow rate of the continuous phase to that of the dispersed phase in the upstream channels is substantially identical to the ratio of the flow resistance of the dispersed phase to that of the continuous phase in the upstream channels,
   and the droplets generated at the nozzle are of uniform size not affected by pressure fluctuations.

In one embodiment of the present method, the dispersed phase and the continuous phase in the upstream channels have the same or substantially the same pressure.

In one embodiment of the present method, the pressure is smaller than

$$\frac{γ {R}_{o} wh}{μ} ,$$

where γ is the interfacial tension of the continuous phase, Rₒ is the flow resistance of the upstream channel delivering the continuous phase, w and h are the width and height of said channel at the nozzle, and μ is the viscosity of the fluid forming the continuous phase.

In one embodiment of the present method,

$$\frac{μ V}{γ}$$

is smaller than 1, where V is the flow velocity of the continuous phase.

In one embodiment of the present method, the ratio of the flow rate of the continuous phase to that of the dispersed phase in the upstream channels is in the range of 0.001-1000.

In one embodiment of the present method, the flow resistance of the dispersed phase and the flow resistance of the continuous phase are 2-100000 times greater than the flow resistance of the downstream channel.

In one embodiment of the present method, the width and/or height of the downstream channel is 10-10,000 times that of the upstream channels.

In one embodiment of the present method, the pressure fluctuations are up to 20 psi.

In one embodiment of the present method, a pressure of the same magnitude is applied to each inlet of said upstream channels. In one embodiment, the pressure is applied by a single pump.

In one embodiment of the present method, the droplets are generated by a shear stress which pinches a thread of fluid into droplets.

In one embodiment of the present method, the upstream channels are configured to produce a cross-flowing structure, a co-flowing structure or a flow focusing structure.

In one embodiment, the present invention provides a method for manufacturing a microfluidic circuit for generating droplets of uniform size, the method comprises:
a) constructing a housing having at least two inlets and a nozzle;
b) constructing in said housing at least one first upstream channel from at least one inlet for introducing at least one first fluid under pressure to form a continuous phase, and at least one second upstream channel from at least one inlet for introducing at least one second fluid under pressure to form a dispersed phase, and the upstream channels merge at said nozzle to generate droplets; and
c) constructing a downstream channel to transport droplets generated at the nozzle to an outlet, and the dimensions of the upstream channels and downstream channel are configured such that the ratio of the flow rate of the continuous phase to that of the dispersed phase in the upstream channels is substantially identical to the ratio of the flow resistance of the dispersed phase to that of the continuous phase in the upstream channels.

In one embodiment of the present method, the microfluidic circuit is configured such that the dispersed phase and the continuous phase in the upstream channels have the same or substantially the same pressure.

In one embodiment of the present method, the pressure is smaller than

$$\frac{γ {R}_{o} wh}{μ} ,$$

where γ is the interfacial tension of the continuous phase, Rₒ is the flow resistance of the upstream channel delivering the continuous phase, w and h are the width and height of the channel at the nozzle, and μ is the viscosity of fluid forming the continuous phase.

In one embodiment of the present method,

$$\frac{μ V}{γ}$$

is smaller than 1, wherein V is the flow velocity of the continuous phase.

In one embodiment of the present method, the ratio of the flow rate of the continuous phase to that of the dispersed phase in the upstream channels is in the range of 0.001-1000.

In one embodiment of the present method, the flow resistance of the dispersed phase and the flow resistance of the continuous phase is 2-100000 times greater than the flow resistance of the downstream channel.

In one embodiment of the present method, the width and/or height of the downstream channel is 10-10,000 times that of the upstream channels.

In one embodiment of the present method, the microfluidic circuit generates droplets of uniform size within a range of pressure of up to 20 psi.

In one embodiment of the present method, the droplets are generated by a shear stress which pinches the thread of fluid into droplets.

In one embodiment of the present method, the upstream channels are configured to produce a cross-flowing structure, a co-flowing structure or a flow focusing structure.

In one embodiment, the present invention provides a microfluidic circuit for generating droplets of uniform size, the microfluidic circuit comprises:
a) a housing comprising at least one first inlet for introducing a first liquid under pressure into at least one first upstream channel to form a continuous phase, at least one second inlet for introducing at least one second liquid under pressure into at least one second upstream channel to form a dispersed phase;
b) a nozzle at one end of said housing, said at least one first upstream channel and said at least one second upstream channel merge at the nozzle to generate droplets;
c) a downstream channel for transporting the droplets generated at the nozzle to an outlet,
   and the dimensions of the upstream channels and downstream channel are configured such that the ratio of the flow rate of said continuous phase to that of the dispersed phase in the upstream channels is substantially identical to the ratio of the flow resistance of the dispersed phase to that of the continuous phase in the upstream channels.

In one embodiment of the present microfluidic circuit, the dispersed phase and the continuous phase in the upstream channels have the same or substantially the same pressure.

In one embodiment of the present microfluidic circuit, the pressure is smaller than

$$\frac{γ {R}_{o} wh}{μ} ,$$

where γ is the interfacial tension of the continuous phase, Rₒ is the flow resistance of the upstream channel delivering the continuous phase, w and h are the width and height of the channel at the nozzle, and μ is the viscosity of fluid forming the continuous phase.

In one embodiment of the present microfluidic circuit

$$\frac{μ V}{γ}$$

is smaller than 1, where V is the flow velocity of the continuous phase.

In one embodiment of the present microfluidic circuit, the ratio of the flow rate of the continuous phase to that of the dispersed phase in the upstream channels is in the range of 0.001-1000.

In one embodiment of the present microfluidic circuit, the flow resistance of the dispersed phase and the flow resistance of the continuous phase is 2-100000 times greater than the flow resistance of the downstream channel.

In one embodiment of the present microfluidic circuit, the width and/or height of the downstream channel is 10-10,000 times that of the upstream channels.

In one embodiment of the present microfluidic circuit, the microfluidic circuit generates droplets of uniform size within a range of pressure of 0.1-20 psi.

In one embodiment of the present microfluidic circuit, the droplets are generated by a shear stress which pinches the thread of fluid into droplets.

In one embodiment of the present microfluidic circuit, the upstream channels are configured to produce a cross-flowing structure, a co-flowing structure or a flow focusing structure.

Throughout this application, various publications are cited. The disclosures of these publications in their entireties are hereby incorporated by reference into this application to more fully describe the state of the art to which this invention pertains.

Throughout this application, it is to be noted that the transitional term “comprising”, which is synonymous with “including”, “containing” or “characterized by”, is inclusive or open-ended, and does not exclude additional, un-recited elements or method steps.

This invention will be better understood by reference to the examples which follow. However, one skilled in the art will readily appreciate that the examples provided are merely for illustrative purposes and are not meant to limit the scope of the invention which is defined by the claims following thereafter.

### EXAMPLES

### Example 1-Microfluidic Circuit Design with Two Inlets

This example illustrates a microfluidic circuit design having one inlet for oil and one inlet for sample according to one embodiment of this invention.

FIG. 2A shows a schematic of a microfluidic circuit according to this embodiment and FIG. 2B shows a microfluidic circuit which is coupled with a chamber for storing droplets generated by the microfluidic circuit.

In FIG. 2A, the upstream inlet channels have winding channels to extend the length and further increase the flow resistance of upstream channels. The width and/or height of the outlet channel can be 10, 100, 1,000, or 10,000 times that of the upstream channels and directly connects to the nozzle after droplet generation. Therefore, the flow resistance of downstream channel is negligible comparing to that of the upstream channels.

Through the adjustment of flow resistance of upstream channels by adjusting one or more of the length, width, and height of the channels, or fluid viscosity, and applying the same pressure on the two inlets, droplets can be generated with desired and consistent droplet size.

In FIG. 2B, the upstream channels are the same as in FIG. 2A, but the nozzle after droplet generation connects instead with a large chamber which usually has larger dimensions than the upstream channels and has negligible flow resistance. This chamber can be designed for droplet storage to collect droplets generated from the droplet generating device.

FIG. 4 show the validation of this design which indicates that the microfluidic circuit was able to produce droplets of uniform diameter when the input pressure changed from 2 psi to 16 psi (data expressed as mean±SD). The image in FIG. 5 shows droplets produced are uniform in size.

### Example 2—Microfluidic Circuit Design with Multiple Inlets

This example illustrates a microfluidic circuit design having one inlet for oil and multiple inlets for other reagents according to one embodiment of this invention.

FIG. 3A shows a schematic of a microfluidic circuit according to this embodiment and FIG. 3B shows a microfluidic circuit which is coupled with a chamber for storing droplets generated by the microfluidic circuit

In one embodiment, droplet generation involves different types of liquids and the microfluidic circuit includes multiple inlets to separately introduce different types of liquids to the droplet generating device. In FIG. 3A, all the upstream channels have winding channels to extend the length to ensure the flow resistance is much higher than the downstream channel. Each of the upstream channels may have the same or different flow resistance, to be determined based on the desired flow rate ratio with respect to each upstream channel. The width and/or height of the outlet channel can be 10, 100, 1,000 or 10,000 times that of the upstream channels. The outlet channel directly connects to the nozzle after droplet generation. Therefore, the flow resistance of downstream channel (Rₜ) is negligible comparing to the upstream channels. By adjusting the flow resistance of each inlet channels (length, width and height of the channels or fluid viscosity) and apply the same pressure on the inlets, different kinds of fluid from different inlets meet at the nozzle and droplets with desired and consistent droplet size are generated.

In FIG. 3B, the upstream channels are the same as in FIG. 3A, but instead of connecting the outlet directly, the nozzle after droplet generation connects with a chamber with large dimensions which has negligible flow resistance as compared to the upstream channels. This chamber can be designed for droplet storage.

### Example 3—Droplet Size and Change in Pressure of Multiple Microfluidic Circuit

According to FIG. 8, a microfluidic system is designed to produce droplets. See FIG. 8 for the specific structure. The upstream flow channels include flow channel 1 and flow channel 2, the flow channel is for oil phase, and the flow channel 2 is for water phase. The downstream flow channel is flow channel 3 for droplet outlet. The flow channel width in the flow channel 1 is 150 μm (9 mm), 75 μm (9.8 mm) and 60 μm (0.5 mm), respectively, the total length is 19.3 mm, and the depth is 25 μm; the flow channel width in the flow channel 2 is 60 μm, the total length is 30 mm, and the depth is 25 μm. The region 3 is a chamber having a length of 3900 μm, a width of 3700 μm, and a depth of 90 μm. The microfluidic chip is etched on a silicon wafer or PDMS material, and bonded with glass sheets. Of which, the flow resistance formed by the upstream channel is much larger than that of the downstream channel, and the ratio of flow resistance satisfies the conditions for droplet formation (in this design, the flow rate ratio satisfies the droplet size of 45 um, and the flow resistance ratio also satisfies this ratio, the microfluidic channel of silicon wafer processing). The droplet size varies within 3 μm within the pressure operating range of 0 to 16 psi.

At this time, the water phase is specifically pure water containing 10% glycerin by weight, and the oil phase is a specific substance such as mineral oil, silicone oil, and fluorinated oil. The same pressure is applied to the channel 1 and channel 2 simultaneously, and the pressure applied each time varies, then the results of the resulting droplet size with the change in pressure are shown in FIG. 4 (for microfluidic channel of wafer processing, the droplets are maintained a uniform size within 45 um). It can be found that, with the change in pressure, the droplet size changes little, basically maintaining at a range of relatively constant size (about 45 um).

The specific experiments have fully demonstrated that the design of the present invention can eliminate the influence of pressure changes on the droplet size. FIG. 5 only shows the apparent shape of the droplets produced under different pressure conditions, and the size is uniform (the material of the microfluidic channel is PDMS). The difference in material will also affect the change of flow resistance of the upstream and downstream. When the amplitude of change in pressure applied is the same (the same as the amplitude shown in FIG. 5), the flow rate ratio will also change due to the difference in materials, and the resulting droplet size is around 60 um.

All patents and publications mentioned in the specification of the present invention are disclosures of the prior art and they can be used in the present invention. All patents and publications referred to herein are incorporated in the references as if each individual publication is specifically referred to separately.

The invention described herein may be practiced in the absence of any one or more of the elements, any one limitation or more limitations that are not specifically recited herein. For example, the terms “comprising,” “consisting essentially of,” and “consisting of” in each instance herein may be replaced with each of the remaining two terms. The terms and expressions which have been employed herein are descriptive rather than restrictive, and there is no intention to suggest that these terms and expressions in this description exclude any equivalents, but it is to be understood that any appropriate changes or modifications can be made within the scope of the present invention and appended claims. It should be understood that, the embodiments described in the present invention are some preferred embodiments and features, and any person skilled in the art may make some changes and variations based on the essence of the description of the present invention, and these changes and variations are also considered to fall into the scope of the present invention and the independent claims and the appended claims.

### REFERENCES

[1] C. N. Baroud, F. Gallaire, and R. Dangla, Lab Chip 10, 2032 (2010).
[2] P. Zhu and L. Wang, Lab Chip 17, 34 (2017)
[3] J. Nunes, S. Tsai, J. Wan, and H. Stone, J. Phys. D: Appl. Phys. 46, 114002 (2013)
[4] K. C. van Dijke, K. C. Schro€en, and R. M. Boom, Langmuir 24, 10107 (2008)
[5] G. Vladisavljević, I. Kobayashi, and M. Nakajima, Microfluid. Nanofluid. 13, 151 (2012).
[6] (a) I. Kobayashi, S. Mukataka, and M. Nakajima, Ind. Eng. Chem. Res. 44, 5852 (2005).
   (b) I. Kobayashi, S. Mukataka, and M. Nakajima, J. Colloid Interface Sci. 279, 277 (2004).
[7] I. Kobayashi, S. Mukataka, and M. Nakajima, Langmuir 21, 7629 (2005).
[8] K. van Dijke, G. Veldhuis, K. Schro€en, and R. Boom, Lab Chip 9, 2824 (2009).
[9] R. Dangla, S. C. Kayi, and C. N. Baroud, Proc. Natl. Acad. Sci. U.S.A 110, 853 (2013).
[10] Lignel, Sarah, et al. Colloids and Surfaces A: Physicochemical and Engineering Aspects 531 (2017): 164-172.
[11] Baret, Jean-Christophe. “Surfactants in droplet-based microfluidics.” Lab on a Chip 12.3 (2012): 422-433.
[12] Hindson, Benjamin J., et al. “High-throughput droplet digital PCR system for absolute quantitation of DNA copy number.” Analytical chemistry 83.22 (2011): 8604-8610.
[13] Kim, Soo Hyeon, et al. “Large-scale femtoliter droplet array for digital counting of single biomolecules.” Lab on a Chip 12.23 (2012): 4986-4991.
[14] Liu, Chunchen, et al. “Single-exosome-counting immunoassays for cancer diagnostics.” Nano letters (2018).
[15] Macosko, Evan Z., et al. “Highly parallel genome-wide expression profiling of individual cells using nanoliter droplets.” Cell 161.5 (2015): 1202-1214.
[16] Wimmers, Florian, et al. “Single-cell analysis reveals that stochasticity and paracrine signaling control interferon-alpha production by plasmacytoid dendritic cells.” Nature communications 9.1 (2018): 3317.
[17] Ward, Thomas, et al. “Microfluidic flow focusing: Drop size and scaling in pressure versus flow-rate-driven pumping.” Electrophoresis 26.19 (2005): 3716-3724.
[18] Garstecki, Piotr, et al. “Formation of droplets and bubbles in a microfluidic T-junction—scaling and mechanism of break-up.” Lab on a Chip 6.3 (2006): 437-446.

1.-22. (canceled)

23. A microfluidic circuit for generating droplets of uniform size, comprising:
a) a housing comprising at least one first inlet for introducing a first liquid under pressure into at least one first upstream channel to form a continuous phase, at least one second inlet for introducing at least one second liquid under pressure into at least one second upstream channel to form a dispersed phase;
b) a nozzle at one end of said housing, wherein said at least one first upstream channel and said at least one second upstream channel merge at said nozzle to generate droplets;
c) a downstream channel for transporting the droplets generated at said nozzle to an outlet,
wherein the dimensions of said upstream channels and downstream channel are configured such that the ratio of the flow rate of said continuous phase to that of the dispersed phase in the upstream channels is substantially identical to the ratio of the flow resistance of the dispersed phase to that of the continuous phase in the upstream channels.

24. The microfluidic circuit of claim 23, wherein the dispersed phase and the continuous phase in the upstream channels have the same or substantially the same pressure.

25. The microfluidic circuit of claim 24, wherein the pressure is smaller than
$$\frac{γ {R}_{o} wh}{μ} ,$$
wherein γ is the interfacial tension of the continuous phase, Rₒ is the flow resistance of the upstream channel delivering the continuous phase, w and h are the width and height of said channel at said nozzle, and μ is the viscosity of fluid forming the continuous phase.

26. The microfluidic circuit of claim 25, wherein
$$\frac{μ V}{γ}$$
is smaller than 1, wherein V is the flow velocity of the continuous phase.

27. The microfluidic circuit of claim 23, wherein the ratio of the flow rate of the continuous phase to that of the dispersed phase in the upstream channels is in the range of 0.001-1000.

28. The microfluidic circuit of claim 23, wherein the flow resistance of the dispersed phase and the flow resistance of the continuous phase is 2-100000 times greater than the flow resistance of the downstream channel.

29. The microfluidic circuit of claim 23, wherein the width and/or height of the downstream channel is 10-10,000 times that of the upstream channels.

30. The microfluidic circuit of claim 23, wherein the microfluidic circuit generates droplets of uniform size within a range of pressure of 0.1-20 psi.

31. The microfluidic circuit of claim 23, wherein the droplets are generated by a shear stress which pinches the thread of fluid into droplets.

32. The microfluidic circuit of claim 23, wherein the upstream channels are configured to produce a cross-flowing structure, a co-flowing structure or a flow focusing structure.

33. A microfluidic device, comprising:
an upstream channel, configured to transport liquids;
a mechanism, configured to produce droplets;
a downstream channel, configured to transport droplets;
wherein, the upstream channel and the downstream channel and the mechanism for producing droplets are in fluidic communication, wherein the mechanism for producing droplets is located at downstream of the upstream channel and at the upstream of the downstream channel, wherein the flow resistance of the upstream channel is greater than or much greater than the flow resistance of the downstream channel.

34. The microfluidic device according to claim 33, wherein the upstream channel comprises a channel for transporting a continuous phase and a channel for transporting a disperse phase.

35. The microfluidic device according to claim 34, wherein the flow resistances of a part of channel for transporting the continuous phase and/or a part of channel for transporting the disperse phase is greater than or much greater than the flow resistance of a part of downstream channel.

36. The microfluidic circuit of claim 33, wherein the length of the upstream channel is greater than or much greater than the length of the downstream channel.

37. The microfluidic circuit of claim 33, wherein the width of the upstream microfluidic channel is smaller than or much smaller than the width of the downstream microfluidic channel.

38. The microfluidic circuit of claim 33, wherein the cross-sectional area of the upstream channel is smaller than or much smaller than the cross-sectional area of the downstream channel.

39. The microfluidic circuit of claim 33, wherein the depth of the upstream channel is less than or much less than the depth of the downstream channel.

40. The microfluidic circuit of claim 33, wherein the upstream channel comprises an inlet for inputting liquid, and the downstream channel comprises an outlet for outputting droplets.

41. The microfluidic circuit of claim 33, wherein the pressure applied to the upstream channel remains constant or remains equal.

42. The microfluidic circuit of claim 33, wherein the pressure applied to the downstream channel is zero or the downstream channel is open to the atmosphere.

43. The microfluidic circuit of claim 33, wherein the ratio of the flow rate of the continuous phase to that of the disperse phase in the upstream channel is substantially identical to the ratio of the flow resistance of the disperse phase to that of the continuous phase in the upstream channel.

44. The microfluidic device according to claim 43, wherein the ratio of the flow rate of the continuous phase to that of the disperse phase in the upstream channel is in the range of 0.001-1000.

45. The microfluidic device according to claim 43, wherein the flow resistance of the disperse phase and the flow resistance of the continuous phase in the upstream channel are 1-100000 times greater than the flow resistance of the downstream channel.

46. The microfluidic device according to claim 41, wherein the pressure is smaller than
$$\frac{γ {R}_{o} wh}{μ} ,$$
wherein γ is the interfacial tension of the continuous phase, Rois the flow resistance of the upstream channel delivering the continuous phase, w and h are the width and height of said channel at the nozzle, and μ is the viscosity of the fluid forming the continuous phase.

47. The microfluidic device according to claim 41, wherein the number of capillaries (Ca) is less than one.

48. The microfluidic device according to claim 41, wherein the pressure varies in the range of 0-50 psi; 0-20 psi, 1-5 psi, 6-10 psi.

49.-53. (canceled)
